(19) United States
(12) Patent Application Publication
(10) Pub. No.: US 2004/0202883 A1
(43) Pub. Date: Oct. 14, 2004

(54) Metal-ceramic composite material and method for production thereof

(76) Inventors: Michael Scheydecker, Nersingen (DE); Tanja Tschirge, Goeppingen (DE); Markus Walters, Stuttgart (DE); Karl Weisskopf, Rudersberg (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/479,044

(22) PCT Filed: Mar. 22, 2002
(86) PCT No.: PCT/EP02/03232

(30) Foreign Application Priority Data
May 26, 2001 (DE) 101 25 814.3

(51) Int. Cl. B32B 1/00

(52) U.S. Cl. 428/539.5

(57) ABSTRACT

A metal-ceramic composite material has a ceramic matrix and a metallic phase, which are intermingled with one another, together form a virtually completely dense body and are in contact with one another at boundary surfaces. An interlayer between the metallic phase and the ceramic matrix has a thickness of between 10 nm and 1 000 nm and is composed of reaction products of the metallic phase and the ceramic phase.

### CROSS-REFERENCE TO RELATED APPLICATIONS

This application claims the priority of German Patent Document 101 25 814.3, filed on May 26, 2001 (PCT International Application No.: PCT/EP02/03232), the disclosure of which is expressly incorporated by reference herein.

### BACKGROUND AND SUMMARY OF THE INVENTION

The invention relates to a metal-ceramic composite material having a ceramic matrix and at least one metallic phase, which are intermingled with one another, together form a virtually completely dense body and are in contact with one another at interfaces, and to a process for producing a metal-ceramic composite material.

European Patent Document No. EP 739 668 A2 has disclosed a cylinder liner made from a metal-ceramic composite material. This cylinder liner is fabricated by producing a porous ceramic preform from a ceramic powder and ceramic fibres in a conventional way and then infiltrating this preform with a liquid metal. The cylinder liner formed in this way is then inserted into a casting mould as a core and then surrounded by cast liquid metal. The component which results is a cylinder casing which is locally reinforced by the composite material in the region of the liner.

The drawback of composite materials of this type is the microscopic bonding between the preform and the metallic phase. In the composite material, the ceramic preform forms what is known as the matrix of the composite material. Wetting between the surface of the matrix and the metallic phase (boundary surface) which is less than optimal means that the theoretical strength of the materials is not achieved. Furthermore, composite materials of this type have brittle fracture characteristics in all volume directions, which is determined by the ceramic matrix and cannot be satisfactorily compensated for by the metallic phase.

German Patent Document No. DE 197 50 599 A1 describes a composite material which consists of aluminides (intermetallic compounds of aluminium) and aluminium oxide. In this context, in particular titanium aluminides which form a three-dimensional supporting phase occur. This material has an excellent ability to withstand high temperatures, but is also highly brittle, on account of the high level of aluminides. Moreover, the thermal conductivity drops to virtually the ceramic level.

One object of the present invention is to provide a metal-ceramic composite material which, compared to the prior art, has improved bonding between a ceramic matrix and metallic phases and is distinguished by a higher ductility and thermal conductivity.

The object is achieved by a metal-ceramic composite material having a ceramic matrix and at least one metallic phase, which are intermingled with one another, together form a virtually completely dense body and are in contact with one another at interfaces. The composite material has an interlayer between the metallic phase and the ceramic phase which has a thickness of between 10 nm and 1 000 nm and consists of reaction products of the metallic phase and the ceramic phase. The invention also provides a process for producing a metal-ceramic composite material comprising the steps of shaping a ceramic powder to form a porous ceramic shaped body, infiltration of the shaped body with liquid metal, and reaction between the ceramic particles and the liquid metal to form an interlayer which contains reaction products of the ceramic shaped body and the metal, with a contact time between the liquid metal and the ceramic particles being less than 10 s.

The metal-ceramic composite material according to the invention (referred to below simply as the composite material) is composed of a supporting, porous ceramic matrix, which is fully interspersed with a metallic phase. The ceramic matrix and the metallic phase are in each case linked with one another in all three dimensions. Together, they form a virtually completely dense, monolithic composite material.

In one embodiment of the invention, an interlayer with respect to the metallic phase is present at the surfaces of ceramic grains which form the ceramic matrix. This interlayer consists of reaction products of the ceramic matrix and the metallic phase. It is therefore formed during production of the composite material and securely bonds metal and ceramic to one another at a microscopic level, leading to a significant increase in strength.

The metal of the metallic phase substantially retains its shape and properties, since the connecting interlayer is of very small size, between 10 nm and 100 nm, preferably of 40 nm.

A particularly suitable metal is aluminium or an aluminium alloy. It has a high ductility, a high elongation at break and a high thermal conductivity. In addition, aluminium has a low relative density and can be processed at low temperatures. Also, aluminium has an affinity for entering into reactions with numerous ceramic compounds, thereby forming intermetallic phases in the form of aluminides.

If the aluminium contains magnesium as an alloying content, this is prejudicial to the formation of the interlayer, since magnesium does not form advantageous intermetallic phases. The strength of the composite material may drop when aluminium-magnesium alloys are used. Therefore, it is preferable to use aluminium-silicon alloys which particularly preferably lie close to the aluminium-silicon eutectic. Silicon likewise forms intermetallic phases—silicides—which have positive effects on the formation of the interlayer. In the text which follows, aluminium alloys are also deemed to be encompassed by the term aluminium, for the sake of simplicity.

Oxides of the transition metals are preferably used to form the ceramic matrix. Silicon oxides and boron carbide are also suitable. The oxides may contain several metals (mixed oxides, such as for example spinel); moreover, it is also possible for mixtures of various substances to be present. Ceramic compounds of this type tend to form an interlayer in the manner laid down by the invention.

A crucial factor in selecting the ceramic matrix is its ability to react with the aluminium. The ceramic matrix must not be completely inert with respect to aluminium, as otherwise an interlayer will not be formed, since this requires a controlled reaction between ceramic and aluminium. On the other hand, a spontaneous, complete reaction between the ceramic and the liquid aluminium during the infiltration leads to destruction of the material, rendering it unusable. It has been found that titanium oxide, in particular TiO₂, but also Ti₂O₃, is particularly suitable for forming an interlayer according to the invention.

Titanium oxide reacts spontaneously with the liquid aluminium, but the reactivity is not so high that so much uncontrolled reaction energy is released that the form of the component is destroyed. The reaction between the ceramic and the metal, in particular between the titanium oxide and the aluminium, takes place according to the following reaction schemes (which do not take account of the stoichiometry coefficients):

Me_{I}O+Me_{II}→Me_{II}O+Me_{I}Me_{II} (Eq. 1)

TiO₂+Al+(Si)→Al₂O₃+TiₓAl_{y}+TiₐSi_{b} (Eq. 2)

The meanings of the abbreviations are as follows:

Me_{I}O: Oxide of the metal Me_{I}

Me_{II}: Infiltration metal

Me_{II}O: Oxide of the metal Me_{II} after an exchange reaction with Me_{I} (e.g. aluminides)

Me_{I}Me_{II}: Intermetallic compound

TiₓAl_{y}: Titanium aluminides having the coefficients x and y

TiₐSi_{b}: Titanium suicides having the coefficients a and b

The coefficients x, y, a and b are dependent on the availability of the components during the reaction.

These reactions are locally limited and according to the invention are restricted to the inherently very thin interlayer. The interlayer bonds the ceramic matrix and the metallic phase very firmly to one another, since this is a reaction-bonded compound. This bonding makes a crucial contribution to increasing the strength of the composite material. On the other hand, the majority of the original form of the metal is retained, and the metal is three-dimensionally linked, so that its positive properties, in particular the ductility, come to bear and compensate for the brittle characteristics of the ceramic matrix.

In another embodiment, a high surface area/volume ratio of the ceramic matrix and the metallic phase is particularly advantageous for strong bonding between the ceramic matrix and the metal and therefore for the strength. This means that the interlayer according to the invention likewise has a large surface area, which has positive effects on the strength of the material. An important contributory factor in this respect is a small pore diameter, preferably of between 0.5 μm and 4 μm.

This is directly related to a fine grain size distribution of the ceramic matrix. The mean grain size distribution is preferably less than 1 μm, and is particularly preferably 0.3 μm. The mean grain size in this case stands for what is known as the D₅₀ value, which describes the maximum frequency of the grain size. The range of the distribution function and its shape may vary, so that even relatively large grains of up to 5 μm may occur.

The small pore diameter and the fine grain size distribution lead to very thin-veined, greatly branched pore channels which are filled by the metal and homogeneously surround the ceramic matrix. This has positive effects on the microstructure and strength of the composite material.

A further embodiment of the invention consists in a process for producing a metal-ceramic composite material.

The process firstly comprises a shaping process, which forms a porous ceramic shaped body. This shaped body is then infiltrated with a liquid metal, leading to a reaction at the surface of ceramic particles of the shaped body. In this reaction, a thin interlayer is formed between the metal and the ceramic matrix. The end product of the process is a homogeneous, virtually completely dense composite material.

For shaping, it has proven particularly expedient for the fine grains of the ceramic powder to be combined to form agglomerates. Agglomerates of this nature preferably have a diameter of from 5 μm to 50 μm. The agglomeration can be carried out by spraying from a suspension or by mixing with the addition of a liquid auxiliary (e.g. water).

This process results in a free-flowing, agglomerated powder which can be poured into a press mould, where it can be homogeneously distributed, e.g. by shaking, and compacted. During the pressing operation, the relatively soft agglomerates break open and are pressed together to form a microporous body. In principle, it is possible to use all ceramic shaping processes, for example including slip casting, but for most geometries pressing will be the most economical method.

The infiltration of the porous ceramic shaped body can likewise be carried out by various methods. Firstly, spontaneous infiltration can be effected by means of capillary forces. This only requires a low level of technical outlay, but the ceramic has to be wetted by the liquid metal, which is not the case with all combinations of materials. A further infiltration method consists in gas-pressure infiltration. This can be used if the capillary forces are not sufficient for spontaneous infiltration. In the case of gas-pressure infiltration, the composite material is exposed to an isostatic pressure, which is particularly gentle in the case of complex components. The technical outlay is relatively high and the number of items or production throughput is very low.

The most economical method of infiltration is infiltration by pressure die-casting. In this context, the term pressure die-casting is to be understood as meaning all processes in which the shaped body is inserted into a permanent casting die and liquid metal is introduced into the casting die under pressure. The term encompasses both conventional pressure die-casting and squeeze casting or the low-pressure die-casting process. The pressure applied is at least one bar. The main advantage of pressure die-casting or squeeze casting, in addition to the short cycle times and the fact that the process is suitable for large series production, consists in the fact that the infiltration takes place very quickly (<1 s). The contact time between the liquid metal and the ceramic matrix is in this case so short that it is just possible for the interlayer according to the invention to form. The contact time is up to 10 s, preferably approx. 5 s, before the aluminium solidifies at the ceramic surface. Complete solidification of the aluminium requires about 15 s-20 s. If the metal dwells in the liquid state or the casting temperature is over 750° C., there is a risk of an uncontrolled reaction between the components.

Composite materials of this type are used in components which are subject to particularly high levels of mechanical and frictional load, in particular in internal combustion engines and transmissions, e.g. as bearing materials or sliding blocks, as heat sinks, brake discs or mechanical chargers.

Preferred embodiments of the invention are described below with reference to a FIGURE and on the basis of two examples.

### BRIEF DESCRIPTION OF THE DRAWING

The FIGURE diagrammatically depicts a microstructure of the composite material according to the invention.

### DETAILED DESCRIPTION OF THE EMBODIMENTS

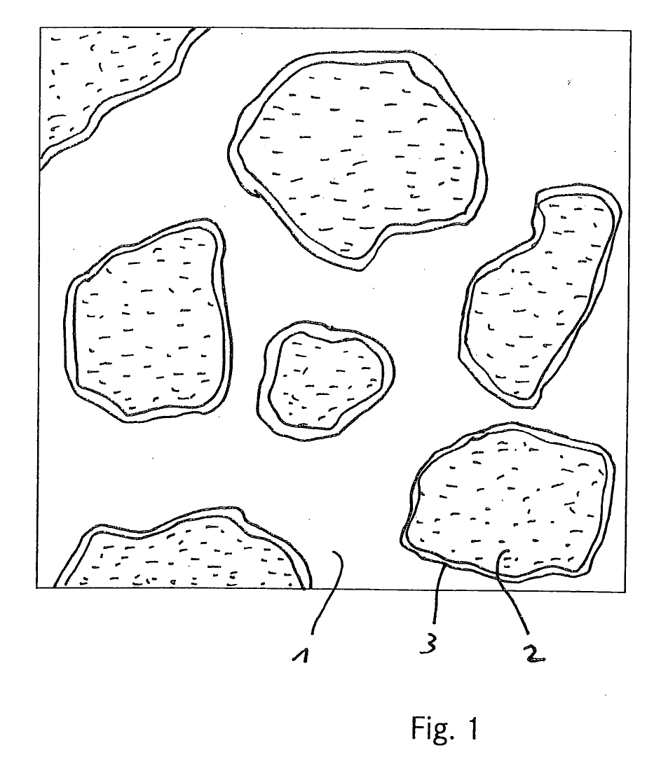

The edge length of the microstructure excerpt shown in FIG. 1 is approx. 1 μm. The microstructure contains an aluminium phase 1 and a ceramic matrix 2. The particles of the ceramic matrix 2 consist of titanium oxide and are covered by an interlayer 3 in accordance with the invention, which forms a separating layer between the aluminium 1 and the titanium oxide 2. The interlayer 3 consists of titanium aluminides, such as TiAl₃ and TiAl, and of aluminium oxide. The titanium oxide particles 2 form a three-dimensional framework which is interspersed with pore passages. The pore passages in the composite material have in turn been filled with aluminium 1. FIG. 1 shows a two-dimensional representation of the microstructure, giving the impression that the titanium oxide particles 2 are not in contact with one another. In the actual three-dimensional microstructure, the titanium oxide particles 2, depending on the pretreatment of the shaped body, are either mechanically locked together (in the case of pressed shaped bodies) or are connected to one another via sintered necks (pressed and sintered shaped bodies).

The process according to the invention is described by the following examples.

### EXAMPLE 1

A suspension of titanium oxide particles which have a mean grain size of 0.3 μm is spray-dried, forming agglomerates with a size of between 10 μm and 20 μm. These agglomerates are introduced into a cylindrical press mould with a diameter of 100 mm, are pre-compacted by vibration and pressed under 200 kN. The pressed shaped body is demoulded and sintered in air for one hour at 1150° C. This sintering leads to the formation of sintered necks between the titanium oxide particles, which contributes to strengthening of the shaped body and is responsible for producing the open porosity of the shaped body, which amounts to approximately 55%.

The shaped body is machined on a lathe so as to give a defined geometry. The geometry of the shaped body is adapted in such a way that the shaped body can be inserted into a pressure die-casting die with a tolerance of 0.5 mm and can be fixed therein. Before it is inserted, the shaped body is preheated to approx. 600° C.

The pressure die-casting die has a runner, a gate and a mould cavity. It is designed in such a way that the mould cavity in which the shaped body is located has spaces which are filled with aluminium and from which the infiltration of the shaped body is fed. The spaces are either removed by machining after the casting operation or form a component which is locally reinforced by the composite material according to the invention.

During the casting and infiltration process, the casting die is filled with aluminium (melting point of 680° C., alloy AlSi12). During the filling operation, the speed of a casting plunger which drives the filling is accelerated from 0.1 m/s to 3 m/s within a time of 200 ms. After the casting die has been completely filled with the aluminium, a pressure of approx. 800 bar is built up within approx. 200 ms. This pressure forces the still liquid aluminium into the ceramic shaped body so that it infiltrates its pores.

During the infiltration, the liquid aluminium reacts with the surface of the titanium oxide particles in accordance with the reaction equation given above (Eq. 2). The cooling of the molten aluminium at the particle surface stops the reaction.

The temperature of the molten aluminium and the preheating temperature of the shaped body are important parameters which can be used to influence the reaction and condition of the interlayer according to the invention. The preheating temperature is between 400° C. and 600° C., and the temperature of the molten aluminium is between 580° C. and 720° C. The optimum combination of these temperature ranges depends on the composition, geometry and microstructure of the shaped body.

The composite material produced in this way has a four-point bending strength σ_{B} of 390 MPa with an elongation ε of 0.4%.

### EXAMPLE 2

A ceramic slip comprising boron carbide is cast into a cuboidal mould (120×90×20 mm) and dried. Then, organic slip additives are burnt out by heat treatment at approx. 600° C., so that the required porosity of the shaped body is established. The shaped body has a strength which is sufficient to allow it to be handled. This shaped body is clamped into a metal mould with an opening and introduced into a gas-pressure infiltration installation with a closed receptacle. The receptacle is evacuated over the course of about 20 minutes and a nitrogen pressure of approx. 100 bar is built up. Aluminium granules are melted in the receptacle by resistance heating, and the prevailing pressure causes the aluminium to be forced through a riser into the opening of the metal mould and into the shaped body.

The liquid metal infiltrates the porous shaped body, with a reaction taking place at the surface of the boron carbide particles analogously to Example 1. The reaction products are aluminium borides. The mode of action of the interlayer is similar to that presented in Example 1 and FIG. 1. The infiltration operation takes about 5 minutes, and the overall process takes about 45 minutes.

What is claimed is:

1-12. (Cancelled)

13. A metal-ceramic composite material comprising:
a ceramic matrix;
at least one metallic phase; and
an interlayer between the metallic phase and the ceramic matrix; wherein
the metallic phase and ceramic matrix are intermingled with one another, together form a virtually completely dense body, and are in contact with one another at the interlayer; and
the interlayer has a thickness of between 10 nm and 1 000 nm, wherein the interlayer consists of reaction products of the metallic phase and the ceramic matrix.

14. A metal-ceramic composite material according to claim 13, wherein the metallic phase is aluminium or an aluminium alloy.

15. A metal-ceramic composite material according to claim 1, wherein the metallic phase is a magnesium-free aluminium alloy.

16. A metal-ceramic composite material according to claim 1, wherein the ceramic matrix comprises at least one oxide of a transition metal or of silicon, or boron carbide.

17. A metal-ceramic composite material according to claim 1, wherein the ceramic matrix comprises titanium oxide.

18. A metal-ceramic composite material according to claim 1, wherein the interlayer comprises titanium aluminides.

19. A metal-ceramic composite material according to claim 1, wherein pores in the ceramic matrix, which are filled by the metallic phase, have a pore radius of between approximately 0.5 μm and 4 μm.

20. A metal-ceramic composite material according to claim 1, wherein grains of the ceramic matrix have a mean grain size of 0.3 μm.

21. A process for producing a metal-ceramic composite material, comprising the steps of:
shaping a ceramic powder to form a porous ceramic shaped body;
infiltrating the ceramic shaped body with liquid metal;
reacting the liquid metal with ceramic particles of the ceramic shaped body; and
forming an interlayer which contains reaction products of the ceramic shaped body and the liquid metal;
wherein a contact time between the liquid metal and the ceramic particles is less than 10 seconds.

22. A process according to claim 21, further comprising agglomerating the ceramic powder to form agglomerates with a diameter of between 5 μm and 50 μm.

23. A process according to claim 21, wherein shaping the ceramic powder to form a porous ceramic shaped body comprises pressing the ceramic powder.

24. A process according to claim 21, wherein said infiltrating is carried out under pressure in a pressure die-casting die.

25. A metal-ceramic composite material comprising:
a ceramic matrix;
at least one metallic phase; and
at least one interlayer present at surfaces of ceramic grains which form the ceramic matrix; wherein
the metallic phase and ceramic matrix are intermingled with one another, together form a virtually completely dense body, and are in contact with one another at the interlayer; and
the interlayer has a thickness of between 10 nm and 1 000 nm, wherein the interlayer consists of reaction products of the metallic phase and the ceramic matrix.
